(19) United States
(12) Patent Application Publication
(10) Pub. No.: US 2009/0191893 A1
(43) Pub. Date: Jul. 30, 2009

(54) Strong media-computer satellite smart telephone with integrated global directory

(76) Inventor: Larry Wardell Smith, Atlanta, GA (US)

Correspondence Address: TALENT IS THE KEY, INC.;LARRY SMITH, 2205 TELHURST STREET SW, ATLANTA, GA, 30310, US

(21) Appl. No.: 12/218,705

(22) Filed: Aug. 30, 2007

Related U.S. Application Data
(63) Continuation-in-part of application No. 10/749,517, filed on Jan. 2, 2004, now abandoned.

(51) Int. Cl. H04W 24/00; H04M 1/00; H04B 1/38; H04W 4/00

(52) U.S. Cl. 455/456.1; 455/457; 455/575.1; 455/566; 455/426.1; 455/556.1

(57) ABSTRACT

A new compact digital satellite communication Media Smartphone capable of making and receiving calls globally and with a global direct directory assistance button, that will display a map and translation page, and is combined with a new Laptop Notebook Computer connected together as one embodiment. The Satellite Media Smartphone has an interface, as does the Laptop Notebook and they are controlled with an Interface Connection Platform Coordinator to coordinate all functions between each operation, and each can operate independently to simultaneously transfer data within each device as one embodiment. Using the Global Position System (GPS) and with latest preferred 2 Quad/2 Duo processors the speed of retrieving and transferring data for directory assistance and to display other internet third party application data to the Media Smartphone through an interface loop, with the option to save a subscriber's requested listings to a personal phone book within the Satellite Smartphone, and to send a backup to a file on the Laptop Notebook securely. Security layers within interfaces are must. There are various services for the Satellite Media Smartphone operation, extended videoing because of being able to store in the virtual memory files of the Laptop, including a facsimile mode that the Laptop Notebook can ask for when an external facsimile machine is attached through the telephone port.

This application is a Continuation-in-Part of co-pending application of Larry W. Smith, Ser. No. 12,218,705, filed on Aug. 30, 2007, entitled STRONG MEDIA-COMPUTER SATELLITE SMART TELEPHONE WITH INTEGRATED GLOBAL DIRECTORY, (CONFIRMATION NO. 6220).

### BACKGROUND OF THE INVENTION

1. Field of the Invention

The present invention relates to PDA Smart Phones, laptop computer, internet media entertainment systems, satellite global integrated directory systems, composed as a dual tele-communication device comprising of a Media Satellite Smartphone combined with a Laptop Notebook Computer as a mobile work station, using an Interface Connector Platform Coordinator (ICPC), as the central processing unit (CPU), to coordinate interfaces operations of all the features within the Smartphone and Laptop housed as one embodiment. It allows the Smartphone to display direct global directory assistance and a language translation page option for conversion to languages and dialects other than English, makings calls, receiving global calls, and other features using the Global Position System (GPS), that will enhance the speed of secure satellite telephone roaming connection for calls; and, the internet connection for both, in order, for all features of this preferred embodiment to be as one embodiment. The combination relates for the Smartphone and secure internet connection within one embodiment with operations performed for both the Smartphone, the laptop notebook computer, and the media access either the can access, even thought, the laptop notebook computer has larger memory and therefore, capable for larger third party downloads and storage, within the present invention.

2. Description of Related Art

There are many Smart phones, laptop computers on the market today, as there are printers and facsimile machines (FAX MACHINES), but there are no GPS media access telephones with integrated directory systems and logos functions option for business subscribers, when they list their business in a local or global business section of a telephone company's telephone data base, along with a laptop workstation with huge memory capacity, and all operation are controlled by the Interface Connector Platform Coordinator (ICPC) encased as one embodiment. The present is related to these devices, but there is an increase demand for complete mobility of a complete mobile office and entertainment system, and the global directory assistance access and options are needed in a growing global economy.

The present invention is a laptop computer and a Media Smartphone combined to create a dual communication device FIG. 4, to be used as a Satellite Media Smartphone with navigation and an integrated global directory assistance information button 42 for a direct access to a global map FIG. 5 with options to a desired global location, without updating listing within the present embodiment, as is needed in most directory assistance programs for the Blackberry and other PDA phones. When a user access the map and information page, after the directory assistance button has been activated, a user have a number of options of language, country, city, and state input of desired information listing, after a user has selected residential, government, and business listings, that a subscriber can negotiate for full page ads with flashing logos, that will pop-up in certain sections and particular businesses addresses. The flashing logos 82-92 for the business advertisement and other Smartphone interface loop connector 79 for all operations of the present embodiment.

The Media Smartphone will be an embedded touch screen that a user can then save the retrieved listing to a personal phone book and also have an option for a file transfer to the laptop notebook phone book 89-92. The Smartphone will also continue to have all of the other available features of Smartphone, PDA, and other relevant the present invention; also, a subscriber has the option to use the laptop notebook computer side FIG. 2 to do extended media access FIG. 6, office work, and other tasks with a wide screen display. The present embodiment interface loops will configure all CPU, 2 Quad/2 Duo-Processors, and other apparatuses to coordinate the present preferred embodiment.

The brains are coordinate through INTERFACE CONNECTOR PLATFORM COORDINATOR (ICPC), or the central circuit board 100, that will coordinate everything that a user will need for work, entertainment, and other options for the present preferred embodiment, i.e. navigation button 106-108 for map access for directions 109, USB Ports 108 for external input, Telephone Port 108, to attach an external fax machine 112, camera, or whatever other external needs a user requires USB access 108.

The GPS system is the delivery system of the fastest speed of internet access, the third party downloads, directory assistance, and other relevant to this tele-communication and entertainment device. When a user has to answer a call while using the laptop side of the present invention, the laptop goes into automatic hibernation FIG. 3.

The cost effective of faxing is a service that is needed in most wireless home offices, and does not need to subscribe to an online faxing service the laptop notebook section of the present invention will be able to play and record Compact Disc and DVD FIG. 2.

There is an efax system for the internet to send and receive faxes online, but the present preferred invention gives the user the option of attaching any external fax machine from any office to the present embodiment, as the present invention prefer to inspire for the future with a port for a phone jack attachment to enable an external fax machine FIG. 1. There is not any data to compare the present preferred embodiment.

This Mobile Media Satellite Telephone will be able to use the internal processors to access and deliver data at a rapid rate, almost instantly, with GPS access, whether a user is online or not to make and receive calls, a button will give a user instant access to the global directories, while most of the others are limited, but there platforms and forms to submit after you go on line or dial some type of number to gain access FIG. 3.

There is a Garmin's GPS portable add on for existing cell and PDA SMART PHONES, but there is no comparison with the present invention. There are no existing telephones to compare to the present invention FIG. 4.

There present invention will have USB outlets and a large capacity hard drive for additional storage capacity, also, telephone Port for a jack attachment to attach an external faxing machine without using a land line. It is much more than any laptop, but the memory capacity may vary, as it will require the latest 2 Quad/2 Duo processors or better for the present preferred embodiment FIG. 4.

There is a UIA READER application mode navigation global keyboard hook, which could possibly enhance the QWERTY keyboard.

Jeff Han's touch screens manipulate pictures or data with multiple fingers. “Multi-touch” technology is not new but has only recently begun to emerge beyond research labs and product prototypes.

New York University research scientist Jeff Han has developed a large, dazzling multi-touch touch-screen computer display where one could manipulate pictures or data with multiple fingers, and founded Perceptive pixel last year to market the technology”.

There is a U.S. Tronics Thuraya satellite telephone that uses a prepaid SIM card. It does not have the capability of the current invention. The Thuraya Satellite Telephone does not compare to the present invention.

In Sussman, U.S. Pat. No. 5,483,586 et al. teaches directory database system stored within a telephone and maintained by a central telephone service provider, the present invention has overcame Sussman with its directory system, since the present embodiment is much more than a directory platform system; in order, to help overcome Sussman integrated directory system (col. 2 line 51 through col. 3 line 34) comprising business logos advertisements (Bell Atlantic, col. 1 line 67 and col 4 lines 28-37 . . . , The present invention will create a flash system, possibly using “Macromedia Flash from Adobe,” to have pop-up flashing logos sites, and not just a flash memory as Sussman uses to store listings.

Sussman “relates to a compact telephone directory system that integrates a subscriber's telephone with an on-line telephone directory database system that is connected to the subscriber's telephone. The firmware for the telephone directory database system is incorporated into the telephone system, whether as part of the telephone, or as an add-on device that integrates with the telephone. The subscriber's on-line telephone directory is maintained by a central telephone directory service provider,” the present invention is much more than compact telephone directory system with on line downloads. It has a GPS access platform communications to the global telephone companies and there is no reason to use any storage space within the present embodiment, other than adding personal listings to the embodiment address book, the global telephone company updates are within the companies database, and when a user enter the require information of country, name, and other options, it will be within an update telephone company's database.

Sussman has to use talk time to update directory listings from CD ROMS then download to a subscriber's telephone; therefore, download time will not be a factor with the present preferred embodiment's directory listing information system as it is with Sussman. Sussman is only limited directory system to produce directory listings. The GPS access for the Global Directories will eliminate storage space and download time for the public directory that is required by previous inventions and directory assistance programs of all yellow pages, Blackberry 411, and others. The present invention uses storage space for a personal phone book after a user location a desire listing, but the need to download to a subscriber's phone is not needed for the present invention; and, with an online personal mobile Media Smartphone satellite Telephone Computer Directory that will be preferred and is able to fax use the online Smartphone access; therefore, makes Sussman not relevant for the present invention.

U.S. Pat. No. 6,052,439, et al. network server the common carriers and central directory service providers who provides downloads for the previous mention inventions platform telephone directory with-yellow page services “teaches a local loop access network providing high-speed access at a committed data delivery rate and natural language processing of spoken directory assistance queries. A user's spoken natural language query is processed and a directory assistance database is searched at the network server platform based on the contents of the query. Search results are provide to the user either through an audio interface or as text on a careen. The user is provided with the option of obtaining more information about certain listings and may select a listing to be automatically dialed. Search results ate prioritized based on any listings previously selected to be automatically dialed and based on the geographical proximity between the establishments in the results list and the address from which the directory assistance query was initiated”.

There are no media integrated directory satellite telephone and advertising system using the GPS access for all internet high speed and security, combined with the preferred notebook/laptop computer in the context of simultaneously transferring of data, all in one embodiment.

The following communication system is available. U.S. Pat. No. 7,233,795, et al., location based communications system, uses the satellites for the global position system and teaches:
1.” A communication system for communication between a first communications unit and at least one other communications unit, comprising:
   first communications unit, comprising:
   radio-telephone means for sending and receiving messages by radio including
   means for initiating, maintaining and terminating said messages;
   means for receiving encoded earth locations of itself in at least two dimensions from a Position Locating Satellite;
   means for encodingly defining a selectable geographic zone having boundaries encoded in at least two dimensions to seek connection with a targeted communications unit;
   means for initiating a radio call in said selected geographic zone, said radio call including a code of said selected zone; and
   second communications unit,
   comprising:
   radio-telephone means for sending and receiving messages by radio including
   means for initiating, maintaining and terminating said messages;
   means for receiving encoded earth locations of itself in at least two dimensions from a Position Locating Satellite;
   means for encodingly defining a selectable geographic zone having boundaries encoded in at least two dimensions to seek connection with a targeted communications unit;
   means for comparing said geographic zone selected by said first communications unit with said encoded earth location of itself to determine agreement therewith, and
      means for responding to said radio call when said encoded earth location of itself is encompassed by said selected geographic zone.” With the present preferred embodiment for the integrated directory system location of the global telephone listings country, language, and a particular listing desire for user, the above communication system could possibly enhance the present invention.

The present invention will be implemented using the preferred communication system and the following preferred micro devices from Micro Devices, Inc. (RFMD), and today there are others later, but to have the complete media embodiment, within this invention. The download times will be faster for both the media Smartphone and the Laptop Notebook side of the present invention.

The other previous directory assistance listing invention downloads from the internet to the telephone device for updates from CD ROMs and other manners to be storage unit within their phone, which is obsolete with the present invention.

With the emergent of W-CDMA wideband [symbol] [symbol] mobile [symbol] [symbol] that utilizes the [symbol] [symbol] [symbol] method of [symbol] [symbol] [symbol] [symbol] [symbol] to achieve higher speeds and support more users compared to the implementation of time division multiplexing (TDMA) used by 2G, 3G, OR MORE GSM networks . . . ,” the coordinated platform of the present invention is the future of mobility of a complete office and accessories, such as the faxing and printing attachments possibilities of the present preferred embodiment.

The present invention provides the original Millennium Media Computer Satellite Telephone with Integrated Global Directory assistance and advertising system that does not need any updating to the telephone, and especially within the present embodiment, complete with a subscriber's ability to enhance their listings to global telephone companies flashing logo systems to highlight listings. This will create an interesting venture through business sections on the website.

The present invention will be housed in a tough and strong material similar to the “Panasonic's Toughbook” material compositions or better to make the present preferred embodiment to better protect from accidental drops, breakage, and loss of data.

There are many related directory listing systems. In Schlachman, U.S. Pat. No. 6,504,925 there is an apparatus for enabling a telephone user to obtain telephone directory information, storing in memory using micro processors to display the information attained locally or regionally; even though, the present invention will use the GPS to transfer data at a faster rate, to the interfaces and the 2 Quad/2 Duo processors or better to display the requested information through interface loop operations, coordinated by ICPC within the present preferred embodiment.

In Gerszberg, U.S. Pat. No. 6,359,881, there is “a new architecture capable of utilizing the existing twisted pair interface between customer premises equipment and an associated serving local switching office . . . to provide a vast array of new services to customers . . . ”, it also uses touch screen, advertising feeds displayed on video phones through the “loop access network provider”, interfaces connectors for information listing and many more services; but, the invention does not need any of the platforms used in previous inventions. An option for audio voice assistance is there for local information, but a charge will probably be added for most global voice assistance. Present preferred embodiment.

There many problems with the IPhones, Blackberry, and other PDA Smartphone are overrated. It turns out that both claims are drastically overstated. The iPhone version of Safari is missing two major building blocks of Web-based applications, Sun Microsystems' Java, which is used to run programs in a browser images. Both are extensively used on both consumer and internal corporate Web sites.

Perhaps more seriously, iPhone only half-supports the technologies used to allow users to create content on Web sites, again an approach widely used on both consumer and business sites. The biggest problem is that most of the time, clicking on an area of a page designed from free-form data entry fails to bring up the iPhone's on-screen keyboard, leaving you no way to enter anything. As a result, such Web-based applications as Google and Zoho's productivity applications and Six Apart's TypePad blogging tool don't work on the iPhone.

The problem is solvable, since Transmedia has figured out a way to make its Glide Mobile suite of applications work on the iPhone. But Apple should come up with a general solution rather than forcing each Web service to find a work-around on its own. Apple should also work with Adobe and Sun to add Flash and Java support to the iPhone and to improve Safari's handling of Javascript.

At the moment, corporate IT departments really don't have much to fear from iPhones because they just aren't equipped to work with enterprise systems. But mobile executives buy the overwhelming majority of Smartphone, and Apple is going to need these customers. It should move quickly to develop the software partnerships required to meet their needs and win their business. The present invention has overcome these problems.

There many features for other PDA, Smartphone, and others using navigation system, and the present embodiment device is not limited to some of the features within this embodiment; therefore, one skilled in the art may want to modify features within the present preferred invention.

With the UIA technology from Microsoft to help the impaired, using the UIA Reader Mode Navigation Keyboard global keyboard hook to navigate pagers at a fast rate of speed, could be used with the present preferred device within one embodiment would be faster with the GPS system of access and receiving data, that will be transferred to a display at rapid speeds and with the latest securities that a subscriber will received from the original destination to the subscriber's Media Smartphone which will have a facsimile mode for the laptop notebook operations of the present embodiment.

With a satellite IP Modem and the largest memory storage, both virtual and other memory saved for a the largest downloads for third party programs, makes the present invention wave of the future. A Media Smartphone memory space, combined with the largest memory space of the Laptop Notebook workstation and entertainment system, CD, DVD, and the game options will make the present invention ahead and beyond the present telecommunication fields.

The present invention is a office away and in the office access, and with all of the option for entertaining, videoing, and coping CD'S and DVD'S, is a personal subscriber dream to be able to be free of office time to attach a printer fax machine and other office tasks will be made accessible at the palm of a subscriber's hand. The new services and cost saving effectiveness of landline and connect cards will needed in today increasing mobile satellite broadband services.

The present clean substitute specification contains no new matter as required under 37 CFR 1.125(b).

### SUMMARY OF THIS INVENTION

The transceiver will receive the satellite signal for a particular country's directory; Therefore, entering that country's directories and giving a particular country's bell the flash system to have pop-ups for their business subscribers, and if desired it will provide direction to a location, in whatever, country the user is operating from.

The videophone will provide unlimited time to film video and to download into the laptop operation virtual memory storage, thereby, eliminating the thirty second video as most mobile video operation; it will give a camcorder access within this embodiment.

Registration from one mobile substation to a land substation signal will automatically registrar to the incoming inquiry for directory listings. Call routing will be the switch that is also automatic as the GPS system is being configured to a user's request. Using the Thuraya Satellite system to enhance the present invention is preferred in combination with local systems for local directory information and with a Satellite IP modem. The speed will be faster than the previous telephones on the market.

The Interface Loop System Connectors (ILSC) for transferring data within and from Media Smartphone to the Laptop notebook and vice versa is multiplexing task will be very cost effect for the individual subscriber. Everyone will benefit with one device capable of attaching a facsimile machine and faxing without going to an online option, because of limitations, the fax loop and activation of the phone port gives the unique service to scan, copy, and fax without the need and cost of a land line telephone, because of the Satellite Media Smartphone and the Laptop Notebook Interface Loop Platform to program many operations and services for consumers at a cost cutting effect, give multi-media tasks, sub ports access ready, blue tooth, speaker, and other globally, an enhanced direct directory assistance operation with business advertising system logos, and many more features and options.

The present preferred invention has the ability to have faster transfer data with security features from the Smartphone operations to the Laptop Notebook with the help of 2 Qual/2 Duo processors of each coordinating for a complete telecommunication operation that not only to make and receive calls, with the direct telephone access gives the executives and their work force the ability to achieve more wok in the field without the need for Wi-Fi access is never again needed.

The present invention advantage of a complete mobile office will be able to save a lot of time and energy to connect to Wi-Fi, and the energy of transportation to reach a hotel to have access to the Wi-Fi there or any other Wi-Fi cafe, there are no need for any type of air card/connect to USB, or any other connection for internet. The operations of the 2 Quad/2 Duo Processors receiving information with the help of the GPS systems will uniquely transform the telecommunication systems, both wireless and other wise. The present wireless computer work shop, a subscriber will have the advantage of two workshops in one embodiment.

The present preferred embodiment will eliminate a user the need to use the limited on line fax system and the need to get to an office and landline telephone hook-up to a facsimile machine to fax document to other clients or associates, with the present preferred embodiment will be able to do all as a complete mobile office, and it will save a subscriber much time, money, resources, and have a change in the way businesses will operate in the field and offices.

The present invention video camera will have the ability to do unlimited videoing, because of the storage capacity of the Laptop Notebook virtual memory and mind of one skilled in the art having the benefit of the teachings presented in the foregoing descriptions and their associated drawings. Therefore, it is to be understood that the invention is not limited to the specific embodiments disclosed, and that other modifications and embodiment are intended to be included within the scope of the invention, in accordance with the claims, drawings, illustrations and equivalents thereof.

### BRIEF DESCRIPTION OF THE DRAWINGS

FIG. 1 Is an open view of the Satellite Media Smartphone Connected to the Laptop Notebook Computer through the Central Interface Connector Coordination Platform (CICCP), to the GPS service provider with some of the enhanced services and features of the present preferred embodiment, accordingly to the invention;

FIG. 2 Is an open view of the Laptop Notebook, it's interface base and the different features and services available for a subscriber. There is also a side view of the entire embodiment, in accordance to the present invention.

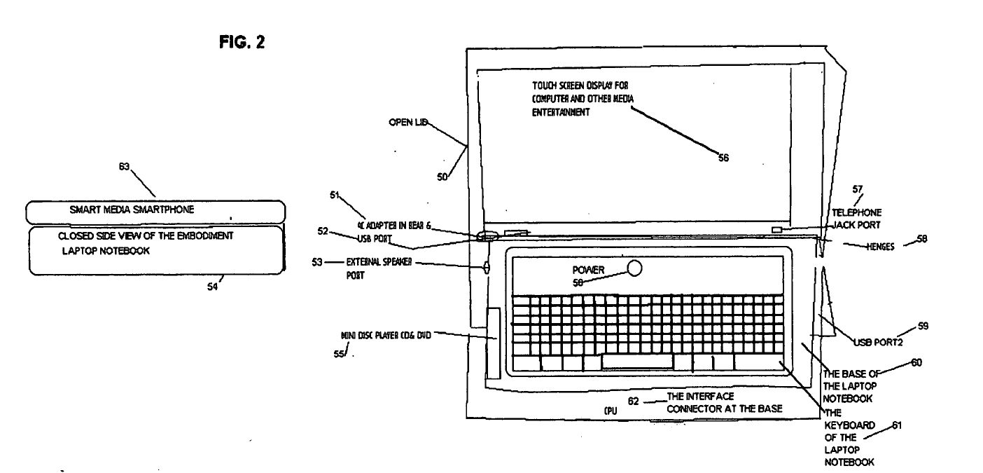

FIG. 3 Diagram is a block diagram along with drawings of the Satellite Media Smartphone and it's interface base panel shoeing directory listing information operations, making an receiving call and shoeing the GPS service provider connection to an orbiting satellite for direct access to service providers around the globe to collect and transfer data requested information from a particular local telephone data base, accordingly to the present preferred embodiment;

FIG. 4 is a complete view image of the present preferred embodiment, shoeing features and services that is available for a subscriber.

FIG. 5 is an interface loop diagram showing the global directory assistance button activated to fine a particular listing within a country, state, or local regional listing, whether a translation of a country language has to be converted or not to request for a listing using the/satellite Media Smartphone where a listing will be displayed, and after finding the needed listing and it being displayed, a user can save it to a personal phonebook on the Smartphone and have an option to transfer and have it stored in an file on the Laptop Notebook operations.

FIG. 6 is an interface loop central operations diagram using the ICPC to coordinate all loop operations in conjunction with GPS service provider platform that will get a subscriber to a particular location rapidly for directory listings and other internet access within the present preferred embodiment.

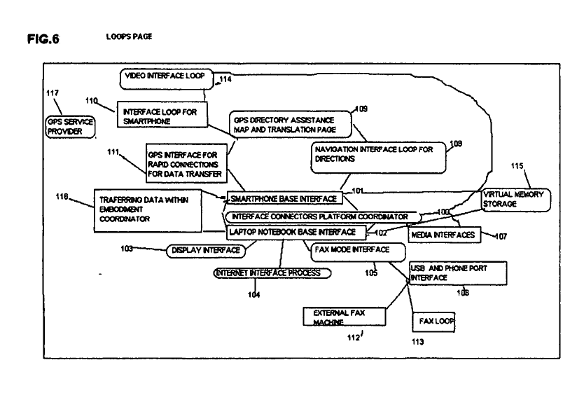

### DESCRIPTION OF PREFERRED EMBODIMENT

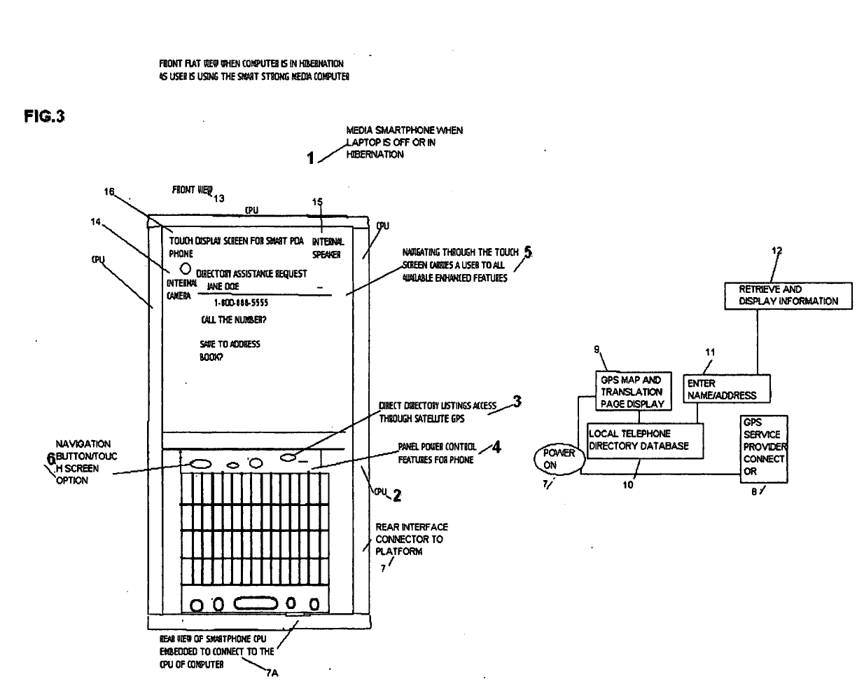

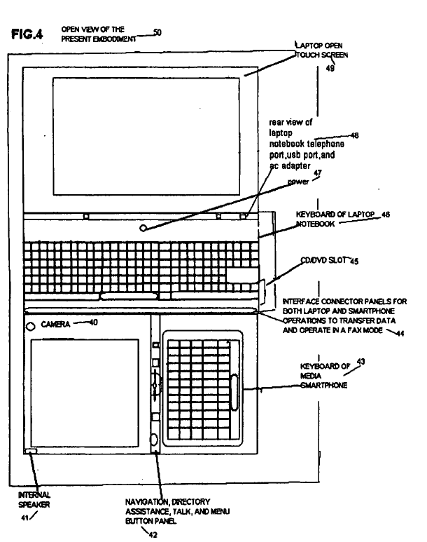

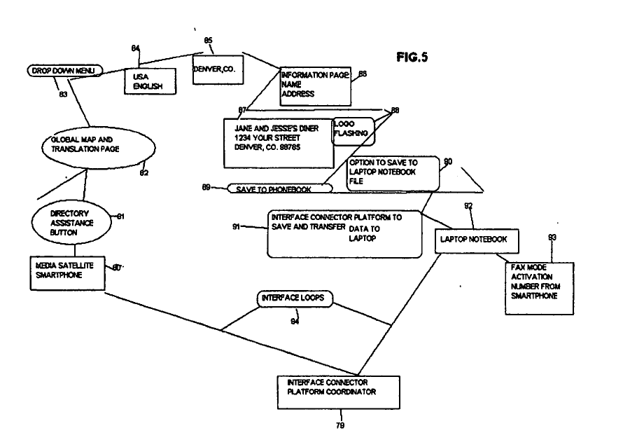

FIG. 7 This invention is Satellite Media Smartphone navigation equipped FIG. 3, with a button for direct global directory information listings and advertising networking system FIG. 5 embedded in a strong break/shock proof material and Laptop Notebook computer together as one embodiment FIG. 4;

There will be no need to download global local directories to subscriber's memory storage space, because of the access to global directory sate based with ability of the global position system (GPS), that will produce the most recent updates of the global telephone companies to a subscriber's display screen FIG. 5;

The translation of a language/dialect option 82 comes into effect when the button is pushed for directory information listings, a global map FIG. 3, will be displayed to choose a country or local city of a particular of a region with an optional drop down list of categories of countries names FIG. 5 for the user to choose from, then a user can enter the name of the person, address or the business listings desired for the directory information 87.

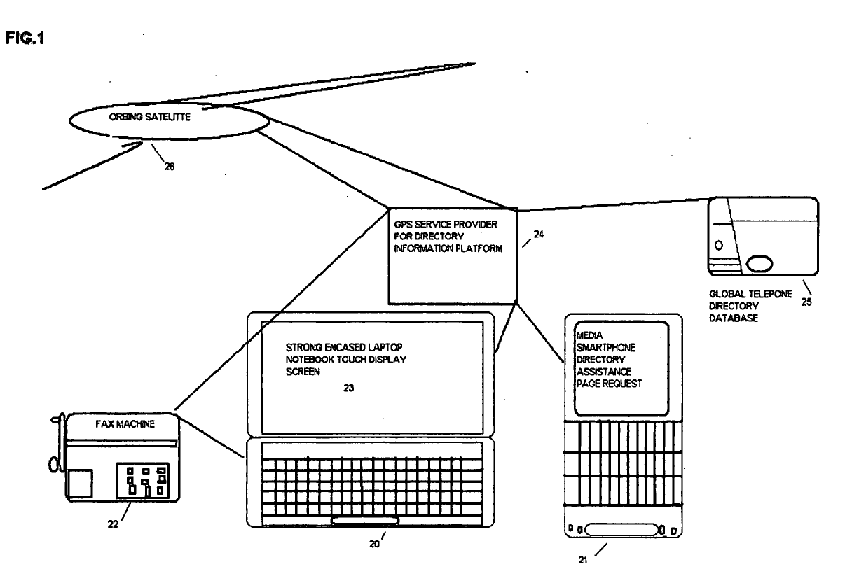

This device is capable of making all global calls using the roaming GPS system, and after locating the desired listing information. The user will have the ability to save the information to the personal phone book storage memory area 89 of the Smartphone and has the option to transfer the data to a file in the Laptop Notebook computer side 90 with the fast 2 Quad/2 Duo processor coordinated with an interface; Therefore, giving a user internet access for the Satellite Media Smartphone and media computer through an interface connection within one embodiment FIG. 1.

The computer will be in hibernation for regular computer usage when a user is answering, making calls, or using other third party applications on the Media Smartphone FIG. 3, afterwards a user can continue work assignments that was interrupted by the need to use the Media Smartphone when the Mini-Laptop Notebook Computer went into hibernation FIG. 4.

This multimedia embodiment will be the most advance to play games, download secure third party applications, play, copy DVD movies, music and have a highest rate of speed for everything within one embodiment; and both sides can download media player applications for movies, music, television, and much more; also, the Laptop Notebook Computer will have more memory storage space than the Media Phone side and both have an embedded display touch screen that opens into a compact wide screen with a Qwerty Computer Keyboard 49.

The Laptop Notebook display screen would be larger/wider than the embedded telephone side. The Smartphone has access to any area of the world with the use of GPS system access when roaming is enable for calls; and for the first time, a user can have an option to route a call through an attach an external facsimile machine FIG. 1, for faxing using the Smartphone number FIG. 5 of the present embodiment; therefore, produce a complete mobile work station, play station entertainment station, and Satellite Media Smartphone access to the universe in one embodiment device. The cost effective of faxing is a service that is need in most wireless home offices, and does not need to subscribe to an online faxing service, and there is no need for a landline phone line to operate, scan, copy, and faxing operations.

What is claimed is:

1. A GPS dual telecommunication system Smartphone combined with a Laptop Notebook Computer operation comprising of:
a. A Media Integrated Global satellite Smartphone complete with an Integrated Global Directory Information System with direct access assistance button, that will display a global map, drop down menu, translation and text information page of a country, that will bring a user to the desired region and information page to enter name and address, and with loop interface connection to multiple 2 Quad/2 Duo processors for the Media Smartphone to display the retrieved listing information, i.e. a number direction, and address, with option Interfaces Connector Coordinator Platform. It also gives another option to the user to transfer the retrieved listing to a backup file located within the Media Laptop Notebook computer operations housed within the present embodiment;
b. A loop interface at the base of Smartphone and Laptop Notebook and with the Interfaces Connector Platform Coordinator in between to coordinate the simultaneously rapid transferring of secure data to the Media Mini-Laptop Computer files from the media phone directory listing operations, therefore, it gives the Central Operation Platform the ability to coordinate all operations needed to share, transfer data, and create programs within the preferred embodiment;
c. a facsimile mode giving the Media Smartphone Interface connections to activate a fax number that will give the telephone port access to send and receive faxes in coordination with an attached external facsimile machine which will use the Smartphone number to send and receive faxes, as one embodiment housed within a strong break/shock proof housed within one embodiment, accordingly to claim 1;
d. A GPS system to transfer the updated secure global advertising information system page to enter characters, then the section to display a complete page of business listings complete with flashing logos almost instantly with the loop router interface to the advance processors for a subscriber's option to select a desired business listing from telephone companies databases, i.e. the attorney page, home improvement page, or any section desired; then, a subscriber will have the option to search or scan the page for a particular business location and telephone number or to scan other business page sections to fine an alternative business, then have the option to retrieved number and/or automatically dialed number, with another option to save to the subscriber's personal phone book, and another option to save the retrieved number to a file within the Laptop Notebook section through the Central Connector Interface Platform Coordinator, accordingly to claim 1;
e. The ability for a user using the Laptop Notebook Computer, interruption the work and having t answer telephone or make a call from the Smartphone, then Media Mini-Laptop Notebook will automatically go into hibernation when lid is closed for phone usage, in accordance with claim 1;
f. Giving the Media Satellite Smartphone the ability to go into activating a fax mode for faxes for a complete mobile office ability, accordingly to claim 1;
g. An internal camera for the Smartphone that has the option of transferring video and pictures to be saved directly to storage memory space of the Media Smartphone and the option to transfer files to the Laptop Notebook computer memory storage section, thereby, giving the Media Satellite Smartphone extensive memory storage for photos and to record video as a cam camera with unlimited time, because it can be transferred to the Laptop's virtual memory files within the present embodiment, accordingly to claim 1;
h. The telephone port to be activated for faxing with an interface loop when a phone jack is inserted into the telephone port, in order for a user to have the ability of routing the Smartphone number to the attached external facsimile machine to receive and send faxes, in accordance to claim 1;
i. Providing a Global Smart Satellite Media Smartphone that can rapidly download media player secure applications and other available third party applications from the Laptop Notebook operation interface, in accordance of claim 1;
j. A mini-tray slot to insert a CD/DVD to be recorded or played as a media entertainment center within the present preferred embodiment, in accordance of claim 1;
k. Ports for external speakers and blue tooth, is in accordance with claim 1;
l. USB ports for other attachments is part of the present preferred embodiment;
